(19) United States
(12) Patent Application Publication
(10) Pub. No.: US 2026/0196410 A1
(43) Pub. Date: Jul. 9, 2026

(54) MULTILAYER ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: Seul A PARK, Suwon-si (KR); Kyoung Ki MIN, Suwon-si (KR); Seong Min PARK, Suwon-si (KR); Young Kyu PARK, Suwon-si (KR); Hyun Woong NA, Suwon-si (KR); Kyung Ryul LEE, Suwon-si (KR)

(73) Assignee: SAMSUNG ELECTRO-MECHANICS CO., LTD., Suwon-si (KR)

(21) Appl. No.: 19/392,343

(22) Filed: Nov. 18, 2025

(30) Foreign Application Priority Data
Jan. 6, 2025 (KR) 10-2025-0001513

(51) Int. Cl. H01G 4/005; H01G 4/12; H01G 4/232; H01G 4/30; H01G 13/00

(52) U.S. Cl. CPC H01G 4/005; H01G 4/1227; H01G 4/30; H01G 4/232; H01G 13/006

(57) ABSTRACT

A multilayer electronic component includes a body including a dielectric layer and an internal electrode alternately disposed with the dielectric layer, and an external electrode disposed on the body. An internal electrode includes silicide. An interface region, a region extending up to 100 nm from an interface between the internal electrode and the dielectric layer toward an inside of the internal electrode, has an average oxygen element content of 0.75 wt % or less relative to total elements.

### CROSS-REFERENCE TO RELATED APPLICATION(S)

This application claims the benefit of priority to Korean Patent Application No. 10-2025-0001513 filed on Jan. 6, 2025 in the Korean Intellectual Property Office, the disclosure of which is incorporated herein by reference in its entirety.

### TECHNICAL FIELD

The present disclosure relates to a multilayer electronic component and a method of manufacturing the same.

### BACKGROUND

A multilayer ceramic capacitor (MLCC) is a chip-type condenser used in a wide range of electronic products, including imaging devices such as liquid crystal displays (LCDs) and plasma display panels (PDPs), as well as computers, smartphones, and mobile phones. Mounted on printed circuit boards, MLCCs function by storing and releasing electrical energy. Their compact size, high capacitance, and ease of mounting make them essential components in modern electronic devices.

With the rapid growth of the small-sized device industry-driven by wearable and mobile technologies—there is an increasing demand for MLCCs that offer both miniaturization and high capacitance. Achieving these performance goals often requires reducing the thickness of the dielectric layers and internal electrodes within the MLCC structure.

Traditionally, internal electrodes in MLCCs have been fabricated using conductive pastes containing nickel (Ni) powder particles. To achieve thinner internal electrodes, the particle size of the Ni powder has been progressively reduced. However, smaller Ni particles tend to lower the sintering initiation temperature, which can lead to a mismatch in sintering behavior between the internal electrodes and the dielectric layer-typically composed of a perovskite-type compound. This mismatch may result in electrode disconnection, increasing the risk of short circuits and degrading the breakdown voltage (BDV) of the MLCC.

To address these concerns, there is a need for alternative conductive materials related to internal electrodes that can maintain compatibility with the dielectric layer during sintering, while still supporting miniaturization and high capacitance.

### SUMMARY

The present disclosure relates to an improved multilayer electronic component and a method of manufacturing the same.

An aspect of the present disclosure is to provide a multilayer electronic component having excellent internal electrode connectivity and dielectric properties.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and an internal electrode alternately disposed with the dielectric layer, and an external electrode disposed on the body. In embodiments, an internal electrode may include silicide. In embodiments, an interface region, a region extending up to 100 nm from an interface between the internal electrode and the dielectric layer toward the inside of the internal electrode, may have an average oxygen element content of 0.75 wt % or less relative to total elements.

According to example embodiments of the present disclosure, a multilayer electronic component may have excellent internal electrode connectivity and dielectric properties.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic cross-sectional view taken along line I-I′ of FIG. 1;

FIG. 3 is a schematic cross-sectional view taken along line II-II′ of FIG. 1;

FIG. 4 is a schematic enlarged view of region “K1” of FIG. 2;

FIG. 5A is a schematic view of an internal electrode formed of silicide powder particles according to a comparative example, and FIG. 5B is a schematic view of an internal electrode formed of silicide powder particles according to an example;

FIG. 6A is an image obtained by capturing a dielectric layer and an internal electrode of Comparative Example 1 using a scanning electron microscope (SEM);

FIG. 6B is an image obtained by capturing a dielectric layer and an internal electrode of Comparative Example 2 using an SEM;

FIG. 6C is an image obtained by capturing a dielectric layer and an internal electrode of Example 1 using an SEM; and

FIG. 6D is an image obtained by capturing a dielectric layer and an internal electrode of Example 2 using an SEM.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction (X) may be defined as a thickness (T) direction, a second direction (Y) may be defined as a length (L) direction, and a third direction (Z) may be defined as a width (W) direction.

### Multilayer Electronic Component

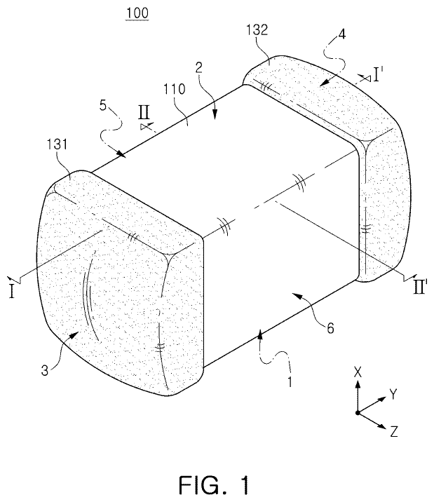

FIG. 1 is a schematic perspective view of a multilayer electronic component according to an example embodiment of the present disclosure.

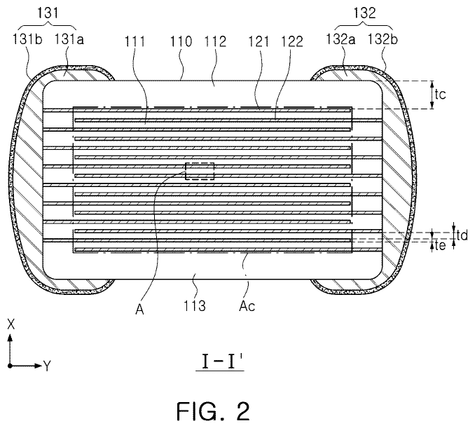

FIG. 2 is a schematic cross-sectional view taken along line I-I′ of FIG. 1.

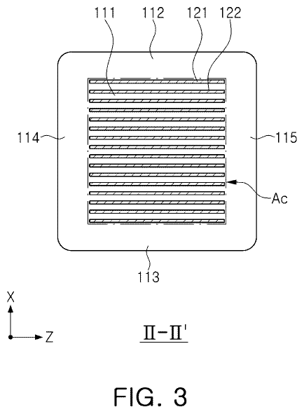

FIG. 3 is a schematic cross-sectional view taken along line II-II′ of FIG. 1.

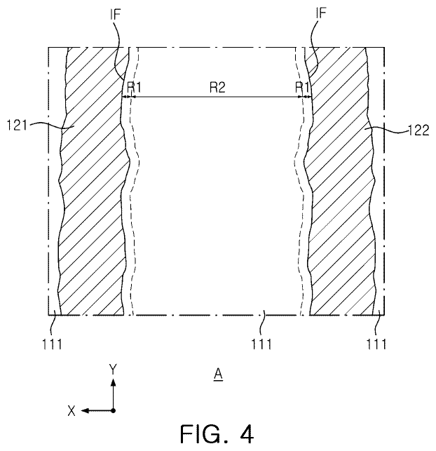

FIG. 4 is a schematic enlarged view of region “K1” of FIG. 2.

Hereinafter, a multilayer electronic component 100 according to an example embodiment of the present disclosure will be described in detail with reference to FIG. 1, FIG. 2, FIG. 3, and FIG. 4. In addition, a multilayer ceramic capacitor (hereinafter referred to as “MLCC”) is described as an example of the multilayer electronic component, but the present disclosure is not limited thereto, and may be applied to various electronic products formed of a ceramic material, such as inductors, piezoelectric elements, varistors, thermistors, or the like.

A multilayer electronic component 100 according to an example embodiment of the present disclosure may include a body 110 and external electrodes 131 and 132.

A specific shape of the body 110 is not limited. However, as illustrated, the body 110 may have a hexahedral shape or a shape similar thereto. Due to shrinkage of ceramic powder included in the body 110 during a sintering process or polishing of corners, the body 110 may not have a hexahedral shape having perfectly straight lines, but may have a substantially hexahedral shape.

In embodiments, the body 110 may have first and second surfaces 1 and 2 opposing each other in the first direction, third and fourth surfaces 3 and 4 connected to the first and second surfaces 1 and 2, the third and fourth surfaces 3 and 4 opposing each other in the second direction, and fifth and sixth surfaces 5 and 6 connected to the first to fourth surfaces 1, 2, 3, and 4, the fifth and sixth surfaces 5 and 6 opposing each other in the third direction.

In embodiments, the body 110 may include a dielectric layer 111 and internal electrodes 121 and 122 alternately disposed with the dielectric layer 111 in the first direction. In embodiments, a plurality of dielectric layers 111, included in the body 110, may be in a sintered state, and adjacent dielectric layers 111 may be integrated with each other such that boundaries therebetween are not readily apparent without using an SEM.

In embodiments, the dielectric layer 111 may, for example, include a perovskite-type compound represented by ABO₃ as a main ingredient. In embodiments, the dielectric layer 111 may, for example, include a perovskite-type compound including Ba and Ti as a main ingredient. In embodiments, the perovskite-type compound may, for example, include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), or Ba(Ti_{1-y}Zr_{y})O₃ (0<y<1).

In the present disclosure, the term “main ingredient” of the dielectric layer 111 may refer to an ingredient accounting for a relatively large proportion by weight percentage or by atomic percentage as compared to other ingredients in the dielectric layer 111, and may refer to an ingredient exceeding 50 wt % relative to a weight of the entire dielectric composition or the entire dielectric layer, exceeding 50 at % relative to the number of atoms of the entire dielectric composition or the entire dielectric layer, or exceeding 50 mol % relative to the number of moles of the entire dielectric composition or the entire dielectric layer.

In embodiments, the internal electrodes 121 and 122 may include, for example, a first internal electrode 121 and a second internal electrode 122 alternately disposed in a first direction with the dielectric layer 111 interposed therebetween. That is, the first internal electrode 121 and the second internal electrode 122, a pair of electrodes having different polarities, may be disposed to oppose each other with the dielectric layer 111 interposed therebetween.

In embodiments, the first internal electrode 121 may be spaced apart from the fourth surface 4 and connected to the first external electrode 131 on the third surface 3. The second internal electrode 122 may be spaced apart from the third surface 3 and connected to the second external electrode 132 on the fourth surface 4.

In the related art, internal electrodes have been formed using an internal electrode conductive paste including Ni powder particles, and sizes of Ni powder particles have been reduced to reduce thicknesses of internal electrodes. However, as the sizes of the Ni powder particles are reduced, a sintering initiation temperature of the Ni powder particles may be lowered, and a sintering mismatch with a dielectric layer may occur. Such a sintering mismatch may degrade connectivity of internal electrodes, causing a short-circuit in a multilayer electronic component and degradation in breakdown voltage (BDV). In the present disclosure, the term “connectivity of internal electrodes” may be defined as a ratio of a length of an actual electrode portion to an overall electrode length of an internal electrode, and may refer to a degree to which a single layer of internal electrode is formed uniformly without disconnection.

According to an example embodiment of the present disclosure, the internal electrodes 121 and 122 may include silicide. Silicide, a compound of silicon and metal, may be chemically stable and may have high electrical conductivity due to a metal-silicon bond. Silicide may have a melting point higher than that of Ni, thereby suppressing a sintering mismatch with the dielectric layer 111, mainly including a perovskite-type compound. Accordingly, the internal electrodes 121 and 122 may have improved connectivity, thereby preventing the occurrence of a short-circuit in the multilayer electronic component 100 and degradation in BDV.

In embodiments, the internal electrodes 121 and 122 may, for example, include silicide as a main ingredient. In the present disclosure, the term “main component” of the internal electrodes 121 and 122 may refer to an ingredient accounting for a relatively large proportion by weight percentage or by atomic percentage as compared to other ingredients in the internal electrodes 121 and 122, and may refer to an ingredient exceeding 50 wt % relative to a weight of the entire internal electrode conductive paste or the entire internal electrode, exceeding 50 at % relative to the number of atoms of the entire internal electrode conductive paste or the entire internal electrode, or exceeding 50 mol % relative to the number of moles of the entire internal electrode conductive paste or the entire internal electrode.

However, when a dielectric layer and an internal electrode are formed by simultaneously sintering ceramic powder particles and silicide powder particles having an oxide film formed on a surface thereof, oxygen concentration at an interface between the dielectric layer and the internal electrode may excessively increase. When oxygen concentration at the interface between the dielectric layer and the internal electrode excessively increases, an interface layer including silicide having a crystal structure different from that of silicide of the internal electrode may be formed at the interface between the dielectric layer and the internal electrode. In addition, a secondary phase may be formed in the dielectric layer by diffusion of silicon included in the internal electrode. The interface layer and the secondary phase may be main causes of degradation in dielectric properties of a multilayer electronic component.

Conversely, according to an example embodiment of the present disclosure, an interface region R1, a region extending up to 100 nm from an interface IF between the internal electrode 121 and 122 and the dielectric layer 111 toward the inside of the internal electrodes 121 and 122, may have an average oxygen element content of 0.75 wt % or less relative to total elements. Since the average oxygen element content relative to total elements in the interface region R1 is 0.75 wt % or less, oxygen concentration of the interface region R1 may be sufficiently lowered to prevent the interface layer or the secondary phase from being formed. Accordingly, the multilayer electronic component 100 may have excellent dielectric properties.

A lower limit of the average oxygen element content relative to total elements in the interface region R1 is not limited, and may be, for example, 0 wt % or more. However, due to diffusion of an oxygen element present in the dielectric layer 111, the average oxygen element content relative to total elements in the interface region R1 may be, for example, 0.03 wt % or more.

The internal electrodes 121 and 122 may include a central region R2, a region excluding the interface region R1. The central region R2 may have an average oxygen element content (wt %), lower than that of the interface region R1. An oxygen content (wt %) of the internal electrodes 121 and 122 may be caused by an oxide film formed on a surface of silicide powder particles, a raw material of the internal electrodes 121 and 122 and/or by a perovskite-type compound represented by ABO₃ of the dielectric layer 111. Accordingly, the central region R2 may have an average oxygen element content (wt %), lower than that of the interface region R1 adjacent to the dielectric layer 111.

In the present disclosure, an average oxygen element content relative to total elements in the interface region R1 may be 0.75 wt % or less, such that oxygen concentration in the interface region R1 may be sufficiently lowered, thereby preventing a change in crystal structure of silicide included in the interface region R1. That is, the interface region R1 and the central region R2 may include silicide having the same crystal structure. Accordingly, when an atomic percentage (at %) of a silicon element in the interface region R1 is denoted by S1, and an atomic percentage (at %) of a silicon element in the central region R2 is denoted by S2, a ratio of S1 to S2 (S1/S2) may be 0.9 or more and 1.1 or less. The same crystal structure of silicide included in the interface region R1 and the central region R2 may be maintained, such that electrical conductivity of the internal electrodes 121 and 122 may be maintained, thereby more effectively improving dielectric properties of the multilayer electronic component 100.

The interface IF between the internal electrodes 121 and 122 and the dielectric layer 111 may be distinguished from each other in terms of color and/or contrast difference between dielectric layer 111 and internal electrodes 121 and 122 in an image obtained by capturing, using an SEM or scanning transmission electron microscope (STEM), a cross-section of the body 110 in the first and second directions. Alternatively, the interface IF between internal electrodes 121 and 122 and dielectric layer 111 may be defined as a point at which contents of elements included in dielectric layer 111 and internal electrodes 121 and 122 sharply change. In an example embodiment, a region in which an atomic percentage (at %) of a Ba element relative to total elements is 9 at % or more may be defined as the dielectric layer 111, and a point at which an atomic percentage (at %) of a Ba element relative to total elements starts to be less than 9 at % may be defined as the interface IF between the internal electrodes 121 and 122 and the dielectric layer 111.

An average oxygen element content in the interface region R1 may be measured by analyzing, using energy-dispersive X-ray spectroscopy (EDS), an image obtained by capturing, using high-angle annular dark-field scanning transmission electron microscopy (HAADF-STEM) or STEM, the interface region R1 of the internal electrodes 121 and 122 disposed on a central portion of a capacitance formation portion Ac after exposing a cross-section in the first and second directions of the multilayer electronic component 100, obtained by polishing the multilayer electronic component 100 up to a central portion in the third direction of the multilayer electronic component 100. Specifically, in the image obtained by capturing the interface region R1 using HAADF-STEM, an average oxygen element content (wt %) in the interface region R1 may be calculated by measuring, using EDS, oxygen element contents at five or more arbitrary points in the interface region R1, and averaging the measured values. Similarly, an average oxygen element content in the central region R2 may be calculated by measuring oxygen element contents (wt %) at five or more arbitrary points in the central region R2 using HAADF-STEM and EDS, and averaging the measured values.

S1 and S2 may be calculated by measuring an atomic percentage (at %) of a silicon element instead of a content (wt %) of an oxygen element using HAADF-STEM and EDS.

A type of the silicide is not limited. The silicide may include one or more of Mo, Co, Zr, Hf, Ta, Ti, Cr, or Ni. The silicide may have a crystal structure such as a tetragonal crystal structure, a cubic crystal structure, an orthorhombic crystal structure, or a hexagonal crystal structure. The silicide may be selected from silicides having a sintering temperature of 1050° C. or higher and/or an electrical conductivity of 10⁶S/m or higher, to be sintered simultaneously with ceramic powder particles for forming the dielectric layer 111. The silicide may be disilicide in which metal and silicon are combined in a 1:2 ratio. The disilicide may have electrical conductivity and sintering temperature higher than those of monosilicide, in which metal and silicon are combined in a 1:1 ratio, and thus may be more suitable for sintering simultaneously with ceramic powder particles for forming the dielectric layer 111. The silicide may include one or more of MoSi₂, CoSi₂, ZrSi₂, or HfSi₂.

The body 110 may include a capacitance formation portion Ac disposed in the body 110, the capacitance formation portion Ac in which a first internal electrode 121 and a second internal electrode 122 are alternately disposed with the dielectric layer 111 interposed therebetween to form capacitance, cover portions 112 and 113 disposed on both surfaces of the capacitance formation portion Ac opposing each other in the first direction, and margin portions 114 and 115 disposed on both surfaces of the capacitance formation portion Ac opposing each other in the third direction. The cover portions 112 and 113 and the margin portions 114 and 115 may have a configuration similar to that of the dielectric layer 111, except that an internal electrode is not included.

The external electrodes 131 and 132 may include a first external electrode 131 disposed on the third surface 3, the first external electrode 131 extending onto portions of the first, second, fifth, and sixth surfaces 1, 2, 5, and 6, and a second external electrode 132 disposed on the fourth surface 4, the second external electrode 132 extending onto portions of the first, second, fifth, and sixth surfaces 1, 2, 5, and 6.

A type or form of the external electrodes 131 and 132 is not limited, and may have a multilayer structure. For example, the external electrodes 131 and 132 may include base electrode layers 131a and 132a in contact with the internal electrodes 121 and 122, and plating layers 131b and 132b disposed on the base electrode layers 131a and 132a.

The base electrode layers 131a and 132a may be sintered electrode layers including a metal and glass. The metal, included in the sintered electrode layer, may include, for example, Cu, Ni, Pd, Pt, Au, Ag, Pb, and/or an alloy including the same. The glass, included in the sintered electrode layer, may include, for example, one or more oxides of Ba, Ca, Zn, Al, B, or Si.

The base electrode layers 131a and 132a may include only the sintered electrode layer including a metal and glass, but the present disclosure is not limited thereto. The base electrode layers 131a and 132a may include, for example, a sintered electrode layer including a metal and glass, and a resin electrode layer disposed on the sintered electrode layer, the resin electrode layer including metal particles and resin.

The metal particles, included in the resin electrode layer, may include one or more of spherical particles or flake-type particles. The metal particles, included in the resin electrode layer, may include, for example Cu, Ni, Pd, Pt, Au, Ag, Pb, Sn and/or an alloy including the same. The resin, included in the resin electrode layer, may include, for example, one or more of epoxy resin, acrylic resin, or ethyl cellulose.

The plating layers 131b and 132b may include, for example, Ni, Sn, Pd, and/or an alloy including the same, and may be formed of a plurality of layers. The plating layers 131b and 132b may be, for example, Ni plating layers or Sn plating layers, and may also be formed in a structure in which a Ni plating layer and a Sn plating layer are sequentially formed. The plating layers 131b and 132b may include a plurality of Ni plating layers and/or a plurality of Sn plating layers.

In the drawings, a structure is described in which the multilayer electronic component 100 has two external electrodes 131 and 132, but the present disclosure is not limited thereto, and the number or shape of the external electrodes 131 and 132 may be changed depending on the form of the internal electrodes 121 and 122 or other purposes.

A size of the multilayer electronic component 100 is not limited. However, in order to achieve miniaturization and high capacitance of the multilayer electronic component 100, in the case of a multilayer electronic component having a size of 1005 (length: about 1.0 mm, width: about 0.5 mm, thickness: about 0.5 mm) or less, in which the number of laminated layers is increased by reducing thicknesses of a dielectric layer and an internal electrode, connectivity of the internal electrode may be highly likely to be degraded due to a sintering mismatch between the dielectric layer and the internal electrode. Accordingly, when the multilayer electronic component 100 according to an example embodiment of the present disclosure is applied to an ultrasmall-sized multilayer electronic component having a size of 1005 (length: about 1.0 mm, width: about 0.5 mm, thickness: about 0.5 mm) or less, the effects of improving connectivity of the internal electrode and dielectric properties may become more remarkable.

An average thickness (td) of the dielectric layer 111 and an average thickness (the) of each of the internal electrodes 121 and 122 are not limited. However, when the multilayer electronic component 100 according to an example embodiment of the present disclosure is applied to an ultrasmall-sized multilayer electronic component in which the average thickness (td) of the dielectric layer 111 is 400 nm or less and/or the average thickness (the) of each of the internal electrodes 121 and 122 is 400 nm or less, the effect of improving connectivity of the internal electrodes and dielectric properties may become more remarkable.

The average thickness (td) of the dielectric layer 111 and the average thickness (the) of each of the internal electrodes 121 and 122 may respectively refer to a size of the dielectric layer 111 in the first direction, and a size of each of the internal electrodes 121 and 122 in the first direction. The average thickness (td) of the dielectric layer 111 and the average size (the) of each of the internal electrodes 121 and 122 may be measured, for example, by scanning, using an SEM, a cross-section of the body 110 in the first and second directions at a magnification of 10,000. More specifically, the average thickness (td) of the dielectric layer 111 may be measured by measuring thicknesses of a single dielectric layer 111 at multiple points of the dielectric layer 111, for example, five points spaced apart from each other at equal intervals in the second direction, and calculating an average value of the thicknesses. In addition, the average thickness (the) of each of the internal electrodes 121 and 122 may be measured by measuring thicknesses of each of the internal electrodes 121 and 122 at multiple points of each of the internal electrodes 121 and 122, for example, five points spaced apart from each other at equal intervals in the second direction, and calculating an average value of the thicknesses. The five points, spaced apart from each other at equal intervals, may be designated in the capacitance formation portion Ac. When such average value measurement is performed on ten dielectric layers 111 and ten internal electrodes 121 and 122, the average thickness of the dielectric layer 111 and the average thickness of each of the internal electrodes 121 and 122 may be further generalized.

An average thickness (tc) of each of the cover portions 112 and 113 is not limited. The average thickness (tc) of each of the cover portions 112 and 113 may be, for example, 5 μm or more or 100 μm or less. For example, when the multilayer electronic component 100 has a size of 1005 (length: about 1.0 mm, width: about 0.5 mm) or less, the average thickness (tc) of each of the cover portions 112 and 113 may be 5 μm or more or 35 μm or less. Here, the average thickness (tc) of each of the cover portions 112 and 113 may refer to an average thickness of each of a first cover portion 112 and a second cover portion 113. The average thickness (tc) of each of the cover portions 112 and 113 may refer to an average thickness in the first direction of each of the cover portions 112 and 113, and may be a value obtained by averaging thicknesses in the first direction of each of the cover portions 112 and 113, measured at five points spaced apart from each other at equal intervals, in a cross-section of the body 110 in the first and second directions.

An average thickness of each of the margin portions 114 and 115 is not limited. The average thickness of each of the margin portions 114 and 115 may be, for example, 3 μm or more or 100 μm or less. For example, when the multilayer electronic component 100 has a size of 1005 (length: about 1.0 mm, width: about 0.5 mm) or less, the average thickness of each of the margin portions 114 and 115 may be 3 μm or more or 25 μm or less. The average thickness of each of the margin portions 114 and 115 may refer to an average thickness of each of a first margin portion 114 and a second margin portion 115. The average thickness of each of the margin portions 114 and 115 may refer to an average thickness in the third direction of each of the margin portions 114 and 115, and may be a value obtained by averaging thicknesses in the third direction of each of the margin portions 114 and 115, measured at five points spaced apart from each other at equal intervals, in a cross-section of the body 110 in the first and third directions.

### Method of Manufacturing Multilayer Electronic Component

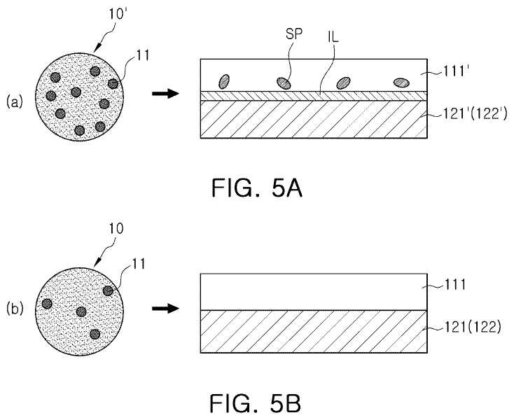

FIG. 5A is a schematic view of an internal electrode formed of silicide powder particles according to a comparative example, and FIG. 5B is a schematic view of an internal electrode formed of silicide powder particles according to an example,

Hereinafter, a method of manufacturing the multilayer electronic component 100 according to an example embodiment of the present disclosure will be described with reference to FIG. 2, FIG. 5A, and FIG. 5B.

### Raw Material Preparation Operation

First, silicide powder particles 10 for forming internal electrodes 121 and 122 may be prepared. A method of manufacturing a multilayer electronic component 100 according to an example embodiment of the present disclosure may include heat-treating silicide powder particles 10 in a reducing atmosphere. Through the heat treatment, an oxide film 11 formed on a surface of each of the silicide powder particles 10 may be removed.

The reducing atmosphere may be, for example, 0.1% H₂/99.9% N₂ to 3.0% H₂/97.0% N₂. In addition, the heat-treating operation may be performed at a temperature of 600° C. or higher and 800° C. or lower for 1 hour or more and 5 hours or less.

Subsequently, a conductive paste including the heat-treated silicide powder particles 10 may be formed. The conductive paste may include the heat-treated silicide powder particles 10, a binder, and an organic solvent. The binder and the organic solvent may be materials known in the art. For example, polyvinyl butyral may be used as the binder, and ethanol may be used as the organic solvent.

First, ceramic powder particles for forming a dielectric layer 111 may be prepared. The ceramic powder particles may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1). BaTiO₃ powder particles may be synthesized, for example, by reacting a titanium raw material such as titanium dioxide and a barium raw material such as barium carbonate. A synthesis method of the ceramic powder particles may include, for example, a solid-state method, a sol-gel method, or a hydrothermal synthesis method, but the present disclosure is not limited thereto.

Subsequently, the prepared ceramic powder particles may be dried and pulverized, and then mixed with the organic solvent and the binder to prepare a ceramic slurry.

### Printing Operation

The ceramic slurry may be coated and dried on a carrier film to prepare a dielectric sheet. The conductive paste may be printed on the dielectric sheet to form an internal electrode pattern. Printing may be performed using, for example, a screen-printing method or a gravure-printing method.

Thereafter, a plurality of dielectric sheets on which the conductive paste is printed may be laminated and pressed to form a laminate. A predetermined number of dielectric sheets on which no conductive paste is printed may be laminated on an upper portion and a lower portion of the laminate to form cover portions 112 and 113 after sintering.

### Cutting and Sintering Operation

Thereafter, the laminate may be sintered to form a body 110 including the dielectric layer 111 and the internal electrodes 121 and 122. The laminate may be cut to have a predetermined chip size, as necessary, and the cut laminate may be sintered. Sintering may be performed in a reducing atmosphere or an oxidizing atmosphere, and at a temperature of 1000° C. or higher and 1400° C. or lower.

Referring to FIG. 5A and FIG. 5B, the silicide powder particles 10 subjected to heat treatment may have low coverage of the oxide film 11, whereas the silicide powder particles 10 not subjected to heat treatment may have high coverage of the oxide film 11. Accordingly, when the internal electrodes 121 and 122 are formed using the silicide powder particles 10 subjected to heat treatment, an interface layer or a secondary phase may not be formed. Conversely, when internal electrodes 121′ and 122′ are formed using the silicide powder particles 10 not subjected to heat treatment, an interface layer IL may be formed at an interface with a dielectric layer 111′, and a secondary phase SP may be formed in the dielectric layer 111′. The interface layer IL may be formed by an excessive increase in oxygen concentration at an interface between the dielectric layer 111′ and the internal electrodes 121′ and 122′.

The interface layer IL may include, for example, silicide having a crystal structure different from that of silicide included in the internal electrodes 121′ and 122′. For example, silicide, included in the internal electrodes 121′ and 122′, may be disilicide, and silicide, included in the interface layer IL, may be monosilicide. The interface layer IL may degrade electrical conductivity of the internal electrodes 121′ and 122′.

The secondary phase SP may be formed by silicon, which is rich in the internal electrodes 121′ and 122′, diffusing toward the dielectric layer 111′. The secondary phase SP may degrade dielectric properties of the dielectric layer 111′.

### External Electrode Formation Operation

Subsequently, external electrodes 131 and 132 may be formed. For example, when base electrode layers 131a and 132a include a sintered electrode layer, the body 110 may be dipped into an external electrode conductive paste including metal powder particles, glass frit, a binder, and an organic solvent, and then the external electrode conductive paste may be sintered at a temperature of 500° C. to 900° C. to form the sintered electrode layer.

For example, when the base electrode layers 131a and 132a include a resin electrode layer, the body may be dipped into a conductive resin composition including metal powder particles, resin, a binder, and an organic solvent, and cured by heat treatment at a temperature of 250° C. to 550° C. to form the resin electrode layer.

In addition, plating layers 131b and 132b may be formed on the base electrode layers 131a and 132a by additionally performing an electrolytic method and/or an electroless plating method.

### Experimental Example 1

Ni powder particles having a diameter of 1 μm or less, BaTiO₃ powder particles, and four types of silicide powder particles (MoSi₂, CoSi₂, ZrSi₂, and HfSi₂) were prepared, and then molded into pellet form using a press. Thereafter, in a reducing atmosphere (H₂ 2.4%), a shrinkage initiation temperature, which is a temperature at which a length of a pellet starts to shrink by 5% or more, was measured using a thermomechanical analyzer (TMA). Table 1 below indicates a shrinkage initiation temperature difference ΔT between Ni and silicide relative to BaTiO₃. That is, when a shrinkage initiation temperature of BaTiO₃ is denoted by T₁ and a shrinkage initiation temperature of Ni and silicide is denoted by T₂, ΔT (%) was calculated as {100×(T1−T2)/T2} and is indicated in Table 1 below.

TABLE 1

Silicide

| Classification | Ni | MoSi₂ | CoSi₂ | ZrSi₂ | HfSi₂ |
|---|---|---|---|---|---|
| ΔT | 48% | 7% | 14% | 12% | 10% |

Referring to Table 1, it may be confirmed that a shrinkage initiation temperature difference between Ni and BaTiO₃ was 48%, whereas a shrinkage initiation temperature difference between silicide and BaTiO₃ was within 15%. Accordingly, it may be confirmed that when an internal electrode is formed of silicide instead of Ni, a sintering mismatch between perovskite-type compounds, included in a dielectric layer, may be suppressed.

### Experimental Example 2

After heat-treating CoSi₂ powder under the conditions indicated in Table 2 below, a sample chip in which a dielectric layer and an internal electrode were laminated was prepared using the heat-treated CoSi₂ powder particles and barium titanate-based powder particles. Specifically, heat treatment was not performed in Comparative Example 1, and heat treatment was performed at 650° C. for about 1 hour in an H₂ 2.4% atmosphere in Comparative Example 2, heat treatment was performed at 650° C. for about 2 hours in an H₂ 2.4% atmosphere in Example Embodiment 1, and heat treatment was performed at 650° C. for about 4 hours in an H₂ 2.4% atmosphere in Example Embodiment 2.

TABLE 2

| Classification | Heat treatment condition |
|---|---|
| Comparative Example 1 | — |
| Comparative Example 2 | 650° C., H₂ 2.4% 1 hr |
| Example 1 | 650° C., H₂ 2.4% 2 hr |
| Example 2 | 650° C., H₂ 2.4% 4 hr |

For each sample chip, an interface region extending up to 100 nm from an interface between an internal electrode and a dielectric layer toward the inside of the internal electrode was analyzed using HAADF-STEM and EDS. Specifically, an oxygen element content (wt %) was measured at five arbitrary points in the interface region. Subsequently, dielectric properties of each sample chip were evaluated.

The dielectric properties were evaluated by measuring a capacitance of a sample using an LCR meter under conditions of 1 kHz and AC 0.5 V/μm, and measuring a relative permittivity of a dielectric layer based on a thickness of the dielectric layer, an area of the internal electrode, and the number of laminated layers. Thereafter, dielectric properties of Comparative Examples 1 and 2 and Examples 1 and 2 were evaluated as normal (Δ), good (∘), or excellent (⊚).

TABLE 3

| | Average oxygen content | Dielectric |
|---|---|---|
| Classification | (wt %) | properties |
| Comparative Example 1 | 4.4 | Δ |
| Comparative Example 2 | 1.2 | ◯ |
| Example 1 | 0.75 | ⊚ |
| Example 2 | 0.03 | ⊚ |

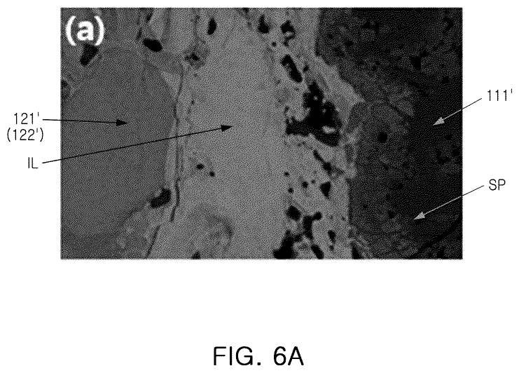

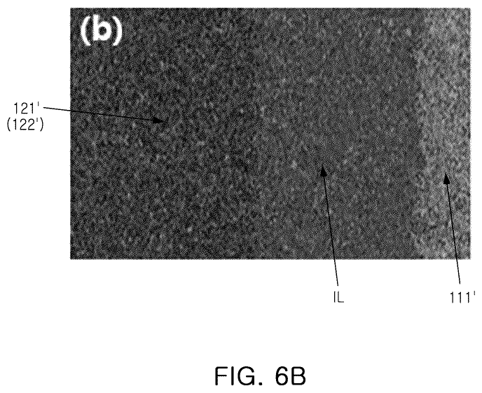

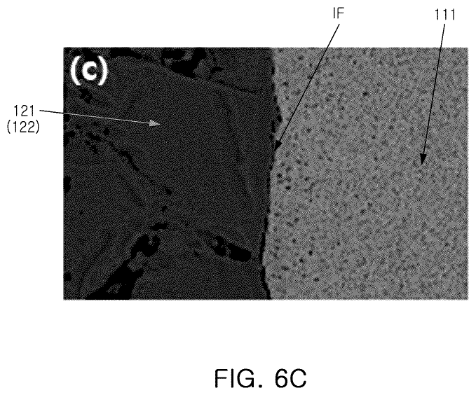

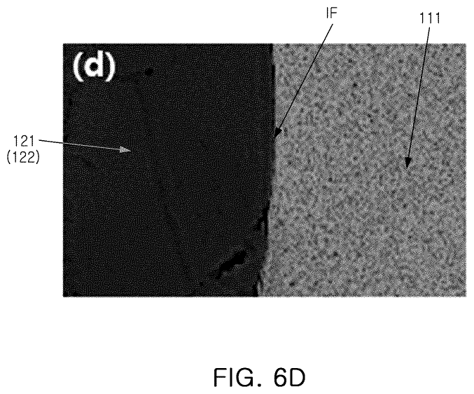

FIG. 6A is an image obtained by capturing a dielectric layer and an internal electrode of Comparative Example 1 using a scanning electron microscope (SEM). FIG. 6B is an image obtained by capturing a dielectric layer and an internal electrode of Comparative Example 2 using an SEM. FIG. 6C is an image obtained by capturing a dielectric layer and an internal electrode of Example 1 using an SEM. FIG. 6D is an image obtained by capturing a dielectric layer and an internal electrode of Example 2 using an SEM.

In Comparative Example 1, it may be confirmed that an interface layer IL was formed at an interface between a dielectric layer 111′ and internal electrodes 121′ and 122′, and a secondary phase SP was formed in the dielectric layer 111′. Accordingly, it may be confirmed that a sample chip of Comparative Example 1 had slightly inferior dielectric properties.

In Comparative Example 2, it may be confirmed that the interface region had a low average oxygen element content (wt %), and the interface layer was not formed at the interface between the dielectric layer 111′ and the internal electrodes 121′ and 122′, as compared to Comparative Example 1. However, the secondary phase SP was also formed in the dielectric layer 111′, and accordingly, it may be confirmed that dielectric properties of sample chips of Comparative Examples 1 and 2 were slightly inferior to those of Examples 1 and 2.

In Examples 1 and 2, it may be confirmed that an interface IF between internal electrodes 121 and 122 and a dielectric layer 111 was clear, and neither an interface layer was formed therebetween nor a secondary phase was formed in the dielectric layer 111. Examples 1 and 2 satisfied an average oxygen element content of 0.75 wt % or less relative to total elements in the interface region, and thus it may be confirmed that sample chips of Examples 1 and 2 had excellent dielectric properties.

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

As used herein, the term “connected” may not only refer to “directly connected” but also “indirectly connected” by means of an adhesive layer or the like. The term “electrically connected” may include both a case in which elements are “physically connected” and a case in which elements are “not physically connected.” In addition, the terms “first,” “second,” and the like may be used to distinguish an element from another element, and may not imply any particular order and/or importance, or others in relation to the elements. In some cases, a first element may be referred to as a second element, and similarly, a second element may be referred to as a first element without departing from the scope of the example embodiments.

What is claimed is:

1. A multilayer electronic component comprising:
a body including a dielectric layer and an internal electrode alternately disposed with the dielectric layer; and
an external electrode disposed on the body,
wherein the internal electrode includes silicide,
an interface region, a region extending up to 100 nm from an interface between the internal electrode and the dielectric layer toward an inside of the internal electrode, has an average oxygen element content of 0.75 wt % or less relative to total elements.

2. The multilayer electronic component of claim 1, wherein the silicide includes one or more of Mo, Co, Zr, Hf, Ta, Ti, Cr, or Ni.

3. The multilayer electronic component of claim 1, wherein the silicide includes one or more of MoSi₂, CoSi₂, ZrSi₂, or HfSi₂.

4. The multilayer electronic component of claim 1, wherein
the internal electrode includes a central region excluding the interface region, and
the central region has an average oxygen element content (wt %) lower than that of the interface region.

5. The multilayer electronic component of claim 1, wherein the internal electrode includes a central region excluding the interface region, and when an atomic percentage (at %) of a silicon element in the interface region is denoted by S1, and an atomic percentage (at %) of a silicon element in the central region is denoted by S2, a ratio of S1 to S2 (S1/S2) is 0.9 or more and 1.1 or less.

6. The multilayer electronic component of claim 1, wherein the interface region has an average oxygen element content of 0.03 wt % or more.

7. The multilayer electronic component of claim 1, wherein the internal electrode includes the silicide as a main ingredient.

8. The multilayer electronic component of claim 1, wherein the dielectric layer contains a perovskite-type compound including Ba and Ti as a main ingredient.

9. The multilayer electronic component of claim 1, wherein an average thickness of the internal electrode is 400 nm or less.

10. The multilayer electronic component of claim 1, wherein an average thickness of the dielectric layer is 400 nm or less.

11. A method of manufacturing a multilayer electronic component, the method comprising:
heat-treating silicide powder particles in a reducing atmosphere;
forming a conductive paste including the heat-treated silicide powder particles;
printing the conductive paste on a dielectric sheet;
laminating a plurality of dielectric sheets on which the conductive paste is printed to form a laminate;
sintering the laminate to form a body including a dielectric layer and an internal electrode; and
forming an external electrode on the body.

12. The method of claim 11, wherein an oxide film formed on a surface of each of the silicide powder particles is removed through the heat treatment.

13. The method of claim 11, wherein the heat-treating operation is performed at a temperature of 600° C. or higher and 800° C. or lower for 1 hour or more and 5 hours or less.

14. The multilayer electronic component of claim 1, wherein the silicide is a disilicide having a metal-to-silicon ratio of 1:2.

15. The multilayer electronic component of claim 1, wherein the silicide has a sintering temperature of 1050° C. or higher and an electrical conductivity of 10⁶ S/m or higher.

16. A method of manufacturing a multilayer electronic component, comprising:
(a) preparing silicide powder particles;
(b) heat-treating the silicide powder particles in a reducing atmosphere to remove an oxide film;
(c) forming a conductive paste including the heat-treated silicide powder particles;
(d) printing the conductive paste on a dielectric sheet to form an internal electrode pattern;
(e) laminating a plurality of dielectric sheets to form a laminate;
(f) sintering the laminate to form a body including a dielectric layer and an internal electrode; and
(g) forming an external electrode on the body.

17. The method of claim 16, wherein the reducing atmosphere comprises 0.1% to 3.0% H₂ and a balance of N₂.

18. The method of claim 16, wherein the heat-treating is performed at 600° C. to 800° C. for 1 to 5 hours.

19. The method of claim 16, wherein the silicide comprises MoSi₂, CoSi₂, ZrSi₂, or HfSi₂.
